(19) United States
(12) Patent Application Publication
(10) Pub. No.: US 2013/0262557 A1
(43) Pub. Date: Oct. 3, 2013

(54) CITY FACILITY MANAGING SERVER AND SYSTEM

(71) Applicants: Gi Jung KIM, Seoul (KR); Ji Seong SONG, Seoul (KR); Jae Young PARK, Seoul (KR)

(72) Inventors: Gi Jung KIM, Seoul (KR); Ji Seong SONG, Seoul (KR); Jae Young PARK, Seoul (KR)

(73) Assignee: LG CNS CO., LTD, Seoul (KR)

(21) Appl. No.: 13/630,088

(22) Filed: Sep. 28, 2012

(30) Foreign Application Priority Data
Sep. 28, 2011 (KR) KR 10-2011-009816

(51) Int. Cl. H04L 29/08

(52) U.S. Cl. CPC H04L 67/10
USPC 709/202

(57) ABSTRACT

Disclosed herein is a city facility managing server and system. The city facility managing server is connected to a plurality of agents, each of which manages at least one city facility according to event processing scripts. The city facility managing server includes a schedule database, a schedule register, and a scheduler. The schedule database stores schedules, each including a specific event processing script for controlling at least one specific city facility. The schedule register registers the schedules in the schedule database. The scheduler continuously reads the stored schedules, registers the schedules in an event queue, reads a schedule corresponding to a current time from the schedule event queue, and sends the read schedule to at least one corresponding agent, thereby allowing the at least one corresponding agent to control a corresponding city facility according to a corresponding event processing script.

### CROSS-REFERENCE TO RELATED APPLICATION

This application claims priority under 35 U.S.C. §119 to Korean Patent Application No. 10-2011-0098163, filed on Sep. 28, 2011, in the Korean Intellectual Property Office, the contents of which is incorporated herein by reference.

### BACKGROUND OF THE INVENTION

1. Field of the Invention

The present invention relates generally to a city facility managing server and system and, more particularly, to a city facility managing server and system that can manage facilities in integrated and independent manners, that can support interactive facilities because citizens can be active agents who can control the facilities, and that can provide a standard based on which different independent facilities can be controlled using agents and scripts.

2. Description of the Related Art

In general, facility management refers to comprehensive management that manages information about public facilities, large-scale factories, conduit and pipe networks, etc., and that conducts the efficient operation and management of the facilities.

City facility management refers to all activities of preserving and improving a constructed cityscape, and predicting, checking and preventing future problems. In city facility management, rest areas are set up and pergolas, fountains, ponds and like are installed therein.

The main agent of the management of city facilities is the city or local government. Such city facilities are not installed and operated in a limited space, but are installed and operated throughout a city. In light of the characteristics of facilities, there are a variety of types of facilities. Since the facilities are managed and operated in a variety of areas and in a variety of forms using a variety of types of equipment and content, the main agents of the management are different from each other. Accordingly, integrated management is required. A related technology is disclosed in Korean Patent Application No. 10-2008-0067673.

FIG. 1 is a block diagram showing a conventional operation management system for city facilities. Referring to FIG. 1, a plurality of data integration devices 1000 installed throughout a city are connected to an operation management system 2000 having a server-client configuration over a wired/wireless network.

Accordingly, the implementation includes the plurality of data integration devices 1000 installed throughout a city area, and configured to capture Closed Circuit Television (CCTV) images or to output sound and to provide data collected from one or more types of sensors, and further includes the operation management system 2000 connected to the data integration devices 1000 over a wired/wireless network, and configured to collect data from sensors and streetlights and output the data to a user and to send control data input by the user to a corresponding data integration device.

However, only an administrator controls the lighting and therefore events such as lighting cannot be controlled by normal users. A related technology is disclosed in International Publication No. WO 2009/004531.

FIG. 2 is a block diagram showing a conventional lighting control system 11 having a user interface 13 that enables the settings of a lighting system so that they can be changed in an interactive manner. Referring to FIG. 2, the user interface (UI) 13 allows for user input 19 using input means, and the lighting control system 11 having the UI 13 may be provided as a computer.

A scene description file 15 acts as a source when the lighting control system 10 computes a graphic two-dimensional (2D) representation of an illustrated scene or room and displays the presentation using the UI 13.

However, although city facilities have developed into interactive facilities all over the world, the corresponding facilities operate in accordance with the authors' intentions, and therefore, spectators should have a passive experience. A variety of attempts to improve the cityscape have been made in mega-scale cities. Although city facilities are configured and managed using a variety of types of content and equipment in order to improve a cityscape, there is no standard that performs the mega-scale control and management of a variety of types of facilities, and therefore, manufacturers and producers manage and control such facilities in an idiosyncratic manner. An integrated system is problematic in that individual pieces of equipment do not operate when trouble occurs in an integrated server or a network and thus control breaks down, in which case the installation of the city facilities becomes meaningless.

### SUMMARY OF THE INVENTION

Accordingly, the present invention has been made keeping in mind the above problems occurring in the prior art, and an object of the present invention is to provide a city facility managing server, which can manage and control the facilities in an integrated manner, and can configure agents in a facility control personal computer (PC) using software and utilize a scheduler, so that the intelligence of the agents is increased and the corresponding facilities and their component equipment can be directly controlled, thereby enabling integrated and independent control.

Another object of the present invention is to provide a city facility managing server, which defines scripts that correspond to a standard for controlling a variety of facilities, and that use common media for managing facilities and their component equipment. The city facility managing server then transfers functions to agents using the scripts, so that the agents read the scripts and perform executions suitable for a standard for each equipment piece/type, thereby enabling the control of a plurality of pieces of equipment based on different standards.

Still another object of the present invention is to provide a city facility managing server, which can configure a show manager in which a citizen can directly participate, and enables a fountain, an electronic signboard, lighting, a moving image, a beam projector, a laser, etc., to be controlled using a mobile terminal and/or the Internet so that they can operate at desired times based on desired content, and therefore citizens can be active control agents, thereby supporting interactive facilities.

In order to accomplish the above objects, the present invention provides a city facility managing server, the city facility managing server being connected to a plurality of agents each of which manages at least one city facility according to event processing scripts, the city facility managing server including a schedule database configured to store schedules each including a specific event processing script controlling at least one specific city facility; a schedule register configured to register the schedules in the schedule database; and a scheduler configured to continuously read the stored schedules, register the schedules in an event queue, read a schedule corresponding to a current time from the schedule event queue, and send the read schedule to at least one corresponding agent, thereby allowing the at least one corresponding agent to control a corresponding city facility according to a corresponding event processing script.

In order to accomplish the above objects, the present invention provides a city facility managing system including a city facility managing server, the city facility managing server being connected to a plurality of agents each of which manages at least one city facility according to event processing scripts, the system including a schedule database configured to store schedules each including a specific event processing script controlling at least one specific city facility; a schedule register configured to register the schedules in the schedule database; a scheduler configured to continuously read the stored schedules, register the schedules in an event queue, read a schedule corresponding to a current time from the schedule event queue, and send the read schedule to at least one corresponding agent, thereby allowing the at least one corresponding agent to control a corresponding city facility according to a corresponding event processing script; and the plurality of agents configured to synchronize time and schedules with those of the city facility managing server, and store event processing scripts, thereby independently operating the facilities even when disconnection occurs.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a conventional operation management system for city facilities;

FIG. 2 is a block diagram showing a conventional lighting control system having a user interface that enables the settings of a lighting system to be changed in an interactive manner;

FIG. 3 is a block diagram showing a city facility managing server according to an embodiment of the present invention;

FIG. 4 is a block diagram showing a city facility managing system according to an embodiment of the present invention;

FIG. 5 is a diagram showing an embodiment in which the city facility managing system, which is shown in FIG. 4, has been embodied;

FIGS. 6A, 6B and 6C are screenshots of administrator screens of a program server that has been implemented in the server of the city facility managing system, which is shown in FIG. 4;

FIGS. 7A and 7B are screenshots of administrator screens of a mobile app that operates the agent of the city facility managing system, which is shown in FIG. 4; and

FIGS. 8A and 8B are screenshots of user screens of a program that registers events in the server of the city facility managing system, which is shown in FIG. 4.

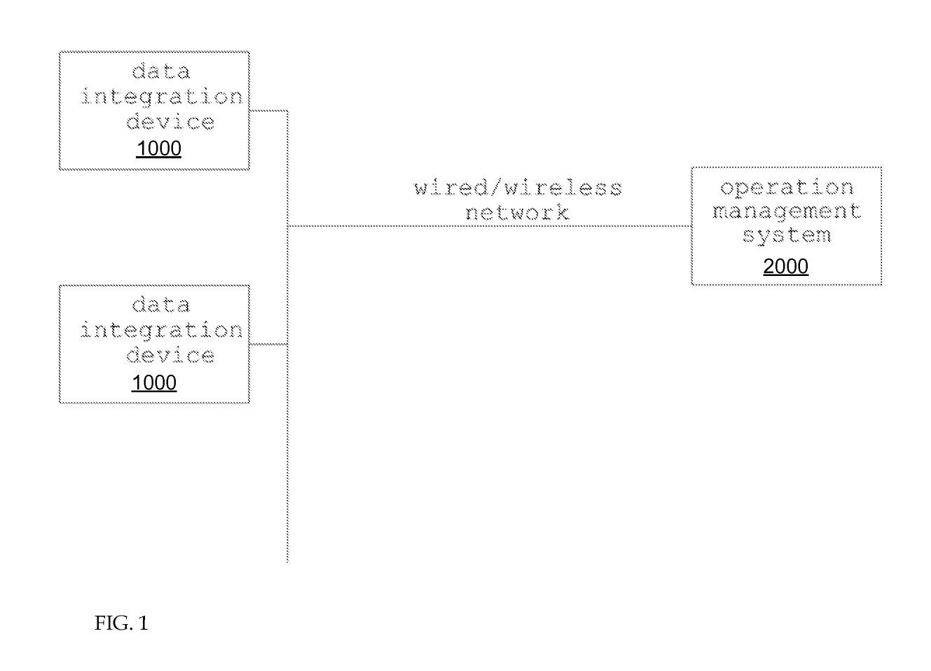

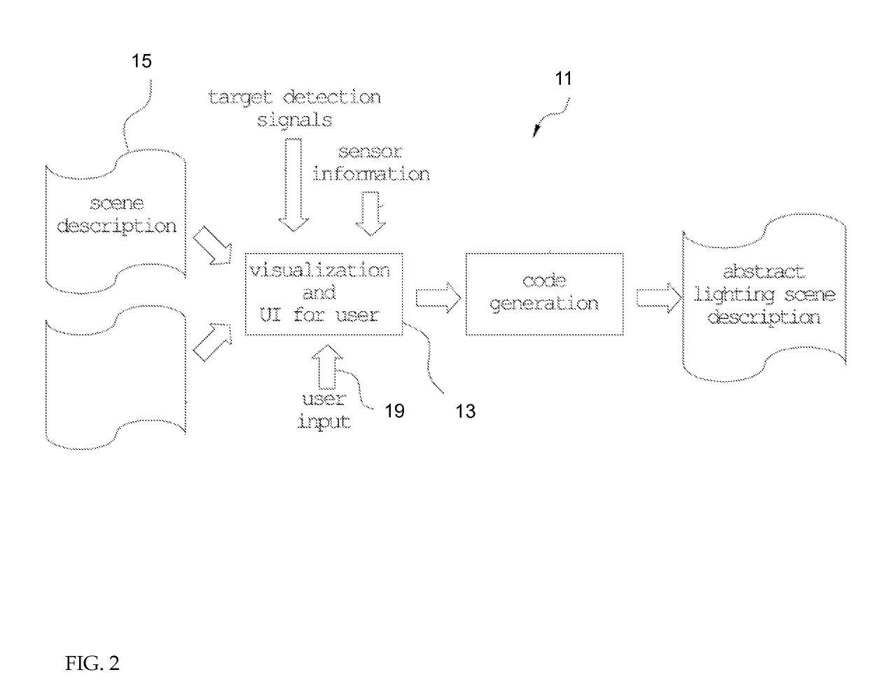

### DESCRIPTION OF THE PREFERRED EMBODIMENTS

The following description will be given to provide structural and functional descriptions of embodiments, and therefore it should be understood that the present invention is not limited by the following embodiments. That is, since the present invention may embrace a number of variations and modifications and have a variety of forms, it should be appreciated that the present invention embraces equivalents. Furthermore, a specific embodiment does not necessarily include all or only the objects and the advantages presented by the embodiments, and therefore the present invention should not be limited by the embodiments.

Meanwhile, the meanings of the terms described in this application should be understood, as follows:

The terms “first,” “second,” etc. are each used to distinguish an element from other elements, and the elements should not be limited by these terms. For example, the first element may be referred to as the second element or, similarly, the second element may be referred to as the first element without departing from the scope and technical spirit of the present invention.

When an element is described as being “coupled to” or “connected to” another element, it should be appreciated that the former element may be directly coupled or connected to the latter element, but they may be coupled or connected together through one or more intervening elements. In contrast, when an element is described as being “directly coupled to” or “directly connected to” another element, it should be appreciated that they are coupled or connected together without the intervention of some other element. Meanwhile, other expressions describing the relationships between elements, such as “between ˜” and “directly between ˜” or “adjacent to ˜” and “directly adjacent to ˜,” should be interpreted in the same manner.

Unless otherwise defined explicitly, singular expressions may include plural expressions. It should be understood that in this application, the term “include(s),” “comprise(s)” or “have(has)” implies the inclusion of features, numbers, steps, operations, components, parts, or combinations thereof mentioned in the specification, but does not imply the exclusion of one or more of any other features, numbers, steps, operations, components, parts, or combinations thereof.

Unless defined otherwise, all terms used herein have the same meanings as generally understood by those having ordinary knowledge in the technical field to which the present invention pertains. Terms generally used and defined in dictionaries should be interpreted as having meanings consistent with meanings construed in the context of the related art, and should not be interpreted as having ideal or excessively formal meanings unless defined explicitly in this application.

Embodiments of the present invention will be described in detail below with reference to the accompanying diagrams.

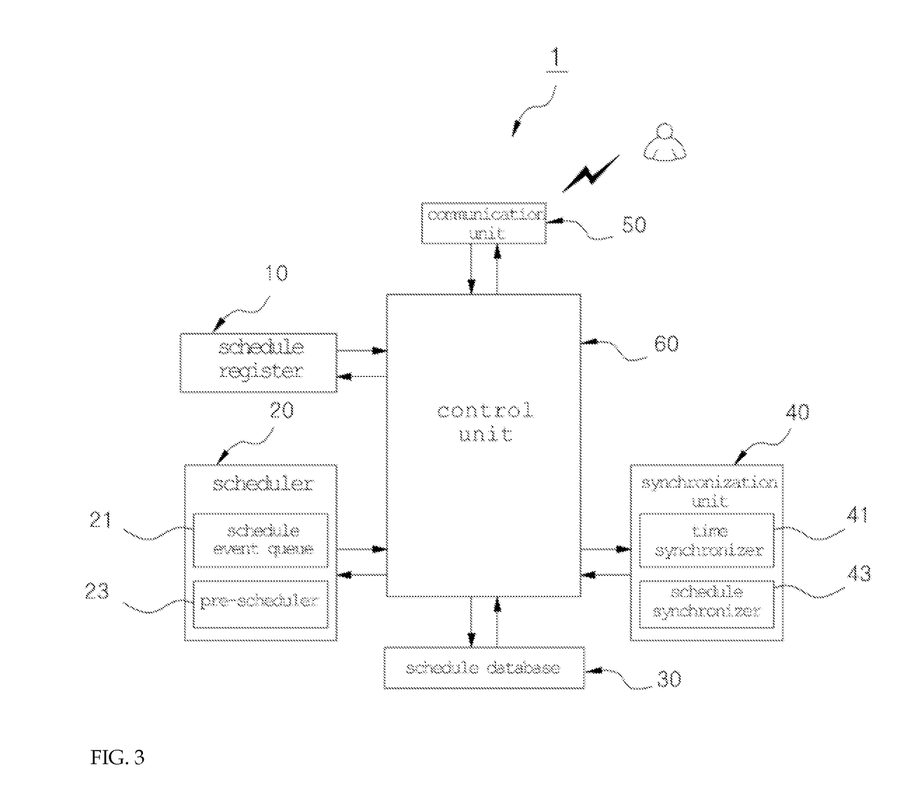

FIG. 3 is a block diagram showing a city facility managing server 1 according to an embodiment of the present invention. Referring to FIG. 3, the city facility managing server 1 according to this embodiment of the present invention includes a schedule register 10, a scheduler 20, a schedule database 30, a synchronization unit 40, a communication unit 50, and a control unit 60.

If an event of a citizen who desires a show event is transferred through the communication unit 50 using the citizen's PC or mobile terminal over a wired or wireless network in order to control a show event in which the citizen can participate, the schedule register 10 checks whether a citizen has reserved an event related to the corresponding equipment at the same time before the control unit 60 stores the schedule in the schedule database 30.

That is, the events of citizens related to the same equipment cannot overlap each other with respect to the same time. In order to avoid this problem, the register 10 checks whether an event related to the same equipment has been registered with respect to the same time, and can approve the citizen-desired event only if an event has not been registered for the citizen-desired time.

For example, it is assumed that the World Music Fountain of Seoul Arts Center located in Seocho-gu, Seoul, Korea operates during a specific time span every day and plans to operate during the time span from 6 P.M. to 10 P.M. on Sep. 23, 2012 and citizen Joe determines that no event has been registered for Sep. 23, 2012, registers event “Pororo” for a time span up to 30 minutes after 7 P.M. on Sep. 23, 2012 and obtains approval.

In this case, if citizen John desires to reserve the event “Mashimaro” at 7 P.M., the World Music Fountain located at Seoul Arts Center is singular, and therefore two events cannot be performed in the same time span. As a result, when John's event request is made, as in this example, the schedule register 10 determines whether an event has already been registered in the schedule database 30 through the control unit 60. Since Joe's event “Pororo” has already been registered, the schedule register 10 sends a rejection message through the communication unit 50.

Furthermore, although the schedule register 10 has a configuration and operating principle similar to those of the scheduler 20, it is separate from the scheduler 20 and performs its role in the form of an independent daemon because it must react promptly and make a reply in response to the control of a citizen. The functions of this monitoring daemon are listed in the following Table 1:

TABLE 1
status information collection function
trouble facility and component equipment detection function
part replacement requiring facility and component equipment detection
function
trouble or part replacement requiring facility and component equipment
alarm function

The trouble equipment detection function is the function of analyzing status information collected from the equipment of a facility and detecting the occurrence of trouble in the equipment. The part replacement requiring equipment detection function is the function of registering the effective operation period of each target equipment and detecting equipment requiring the replacement of a part or periodic examination.

Furthermore, the schedule register 10 functions to issue a command to synchronize the performance of an approved citizen's scheduled show event, to generate a show event sequence for the component equipment of a facility in accordance with a previously approved show event scenario, to register the generated show event sequence in the scheduler 20 in accordance with the schedule of the scenario, to generate the control script of the corresponding equipment in accordance with the designated schedule, and to transfer the equipment control script to the corresponding component equipment when the event occurs. The script is defined as a set of translations that are translated and executed not by a computer processor or a compiler but by some other program.

Furthermore, a show event in which a citizen participates may include a scenario, including the functional and temporal control of at least one specific city facility, as a specific event processing script.

The scheduler 20 includes a schedule event queue 21 and a pre-scheduler 23. The schedule event queue 21 is a spot at which the scheduler 20 registers each schedule and reads events from the schedule database 30, is one basic data structure, and may store data in a first in, first out (FIFO) structure.

The pre-scheduler 23 is configured to check the erroneous operation of at least one specific city facility in advance using at least one agent, prior to fetching a schedule based on the current time. The pre-scheduler 23 is provided to check at least one schedule at the front of the schedule event queue 21, and to delete the corresponding schedule from the schedule event queue 21 if the erroneous operation is not predicted to occur.

The event that was registered by the citizen should be periodically transferred to an agent and be used to make an update. If a facility controlled by the agent is receiving a check or has failed, the event will not occur at the corresponding time even should the event have been transferred to the agent. When the erroneous operation occurs, the schedule is stored in the schedule event queue 21 and then notification will be provided to the citizen later, so that the schedule may be varied, for example, by varying the time. If the erroneous operation does not occur, the schedule is deleted from the schedule event queue 21, thereby eliminating a record of the event.

In this case, the corresponding event may not be immediately deleted, but may be stored for a specific period, so that the citizen can search for it later. Alternatively, the event may be immediately deleted. This is variable.

When the scheduler 20 generates events at predetermined intervals, preferably at intervals ranging from 1 ms to 20 ms, and more preferably at intervals of 10 ms, and compares the times of the events registered in the schedule event queue 21 with the current time, and generates the events, the schedule database 30 may store the approved schedule and event stored in the schedule database 30 by the citizen, for example, with “in World Music Fountain of Seoul Arts Center at 7 P.M.” being associated with the schedule and “Pororo” being associated with the event, in the form of a data structure, such as that shown in the following Equation 1:

In World Music Fountain of Seoul Arts Center at 7 P.M.-Pororo (1)

The synchronization unit 40 includes a time synchronizer 41 and a schedule synchronizer 43. The time synchronizer 41 is configured to manage the current time and to perform synchronization with a plurality of agents. This synchronization may be performed through a Network Time Protocol (NTP) server.

The NTP server manages the Network Time Protocol (NTP), and functions to send time to a client who requests the time according to the NTP. In the case of a system to which components are connected in steps, when notification of time is provided to computers constituting the agents 2 and the server 1, a stratum occurs. The NTP server sends time, that is, the result of computation that is performed based on standard time and an error range attributable to the stratum while referring to a reference and a stratum that were sent by the client when the request was made, to the client. Accordingly, the NTP server can synchronize computers on a network within an error range of 200 ms.

The schedule synchronizer 43 is provided to synchronize the schedule stored in the schedule database 30 with a schedule stored in the corresponding agent. There may be further included a schedule updater (not shown) that synchronizes an updated schedule through the schedule synchronizer 43 without the intervention of the schedule event queue 21 when the schedule stored in the schedule database 30 is updated.

The communication unit 50 is provided to communicate with the citizen over the Internet or through a mobile terminal and to communicate with each agent. The communication unit 50 may include at least one of a WEB, a WAS, and a SOAP. The WAS is a web application server, and is middleware (a software engine) that executes an application for a user computer or a device over the Internet through HTTP. The SOAP (Simple Object Access Protocol) is a communication protocol between entities that enables a web service to be actually used. SOAP is a technology that enables a web service to communicate over the Internet, and may include the SOAP header, the SOAP body, the SOAP Encoding Rules, and the SOAP RPC Representation.

The communication unit 50 transfers event information received from each citizen to the control unit 60. Scripts that the control unit 60 transfers to the individual agents are transferred to the agents through the communication unit 50. The communication between the agents and the city facility managing server 1 may be connected using the SOAP.

The control unit 60 is provided to control each element, to act as a channel for the commands and input and output of each element, to perform control so that each command can be transferred to a corresponding entity, and to command each element to perform a corresponding function. The control unit 60 may perform the function of scheduled distribution of content used in the field, and software run in the control PC. Since a facility is not always operated, but instead operated on a specific date, on a specific day of the week and in a specific time span, the control unit 60 registers the operating schedule of each facility and its component equipment, and transfers commands to control the facility and the component equipment to a corresponding agent in accordance with the schedule.

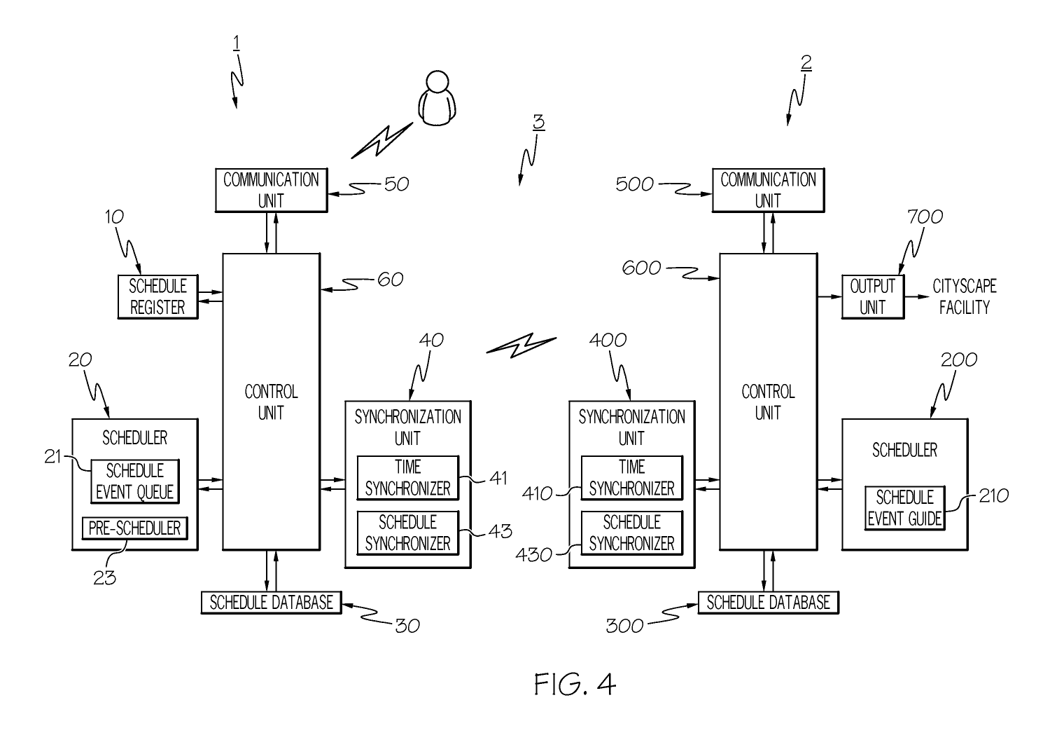

FIG. 4 is a block diagram showing a city facility managing system 3 according to an embodiment of the present invention. Referring to FIG. 4, the city facility managing system 3 according to this embodiment of the present invention includes a city facility managing server 1, and an agent 2.

The city facility managing server 1 according to this embodiment of the present invention includes a schedule register 10, a scheduler 20, a schedule database 30, a synchronization unit 40, a communication unit 50, and a control unit 60.

If an event of a citizen who desires a show event is transferred through the communication unit 50 using the citizen's PC or mobile terminal over a wired or wireless network in order to control a show event in which the citizen can participate, the schedule register 10 checks whether a citizen has reserved an event related to the corresponding equipment at the same time before the control unit 60 stores the schedule in the schedule database 30.

That is, the events of citizens related to the same equipment cannot overlap each other with respect to the same time. In order to avoid this problem, the register 10 checks whether an event related to the same equipment has been registered with respect to the same time, and can approve the citizen-desired event only if an event has not been registered for the citizen-desired time.

For example, assume again that Music Fountain located in Ilsan, Korea operates during a specific time span every day and plans to operate during the time span from 6 P.M. to 10 P.M. on Sep. 23, 2012 and citizen Joe determines that no event has been registered for Sep. 23, 2012, registers event “Tong Vfang Xien Qi” for a time span up to 30 minutes after 7 P.M. on Sep. 23, 2012 and obtains approval.

In this case, if citizen John desires to reserve the event “JYJ” at 7 P.M., the Music Fountain located in Ilsan is singular, and therefore two events cannot be performed in the same time span. As a result, when John's event request is made as in this example, the schedule register 10 determines whether an event has already been registered in the schedule database 30 through the control unit 60. Since Joe's event “Tong Vfang Xien Qi” has already been registered, the schedule register 10 sends a rejection message through the communication unit 50.

Furthermore, although the schedule register 10 has a configuration and operating principle similar to those of the scheduler 20, it is separate from the scheduler 20 and performs its role in the form of an independent daemon because it must react promptly and make a reply in response to the control of a citizen. The functions of this monitoring daemon are listed in the following Table 2:

TABLE 2
status information collection function
trouble facility and component equipment detection function
part replacement requiring facility and component equipment detection
function
trouble or part replacement requiring facility and component equipment
alarm function

The trouble equipment detection function is the function of analyzing status information collected from the equipment of a facility and detecting the occurrence of trouble in the equipment. The part replacement requiring equipment detection function is the function of registering the effective operation period of each target equipment and detecting equipment requiring the replacement of a part or periodic examination.

Furthermore, the schedule register 10 functions to issue a command to synchronize the performance of an approved citizen's scheduled show event, to generate a show event sequence for the component equipment of a facility in accordance with a previously approved show event scenario, to register the generated show event sequence in the scheduler 20 in accordance with the schedule of the scenario, to generate the control script of the corresponding equipment in accordance with the designated schedule, and to transfer the equipment control script to the corresponding component equipment when the event occurs. The script is defined as a set of translations that are translated and executed not by a computer processor or a compiler but by some other program.

Furthermore, a show event in which a citizen participates may include a scenario, including the functional and temporal control of at least one specific city facility, as a specific event processing script.

The scheduler 20 includes a schedule event queue 21 and a pre-scheduler 23. The schedule event queue 21 is a spot at which the scheduler 20 registers each schedule and reads events from the schedule database 30, is one basic data structure, and may store data in a first in, first out (FIFO) structure.

The pre-scheduler 23 is configured to check the erroneous operation of at least one specific city facility in advance using at least one agent, prior to fetching a schedule based on the current time. The pre-scheduler 23 is provided to check at least one schedule at the front of the schedule event queue 21, and to delete the corresponding schedule from the schedule event queue 21 if the erroneous operation is not predicted to occur.

The event that was registered by the citizen should be periodically transferred to an agent and be used to make an update. If a facility controlled by the agent is receiving a check or has failed, the event will not occur at the corresponding time even should the event have been transferred to the agent. When the erroneous operation occurs, the schedule is stored in the schedule event queue 21 and then notification will be provided to the citizen later, so that the schedule may be varied, for example, by varying the time. If the erroneous operation does not occur, the schedule is deleted from the schedule event queue 21, thereby eliminating a record of the event.

In this case, the corresponding event may not be immediately deleted, but may be stored for a specific period, so that the citizen can search for it later. Alternatively, the event may be immediately deleted. This is variable.

When the scheduler 20 generates events at predetermined intervals, preferably at intervals ranging from 1 ms to 20 ms, and more preferably at intervals of 10 ms, and compares the times of the events registered in the schedule event queue 21 with the current time, and generates the events, the schedule database 30 may store the approved schedule and event stored in the schedule database 30 by the citizen, for example, with “in Music Fountain of Ilsan at 30 minutes after 9 P.M.” being associated with the schedule and “Tong Vfang Xien Qi” being associated with the event, in the form of a data structure, such as that shown in the following Equation 2:

In Music Fountain of Ilsan at 30 minutes after 9 P.M.-Tong Vfang Xien Qi (2)

The synchronization unit 40 includes a time synchronizer 41 and a schedule synchronizer 43. The time synchronizer 41 is configured to manage the current time and to perform synchronization with a plurality of agents. This synchronization may be performed through a Network Time Protocol (NTP) server.

The NTP server manages the NTP, and functions to send time to a client who requests the time according to the NTP. In the case of a system to which components are connected in steps, when notification of time is provided to computers constituting the agents 2 and the server 1, a stratum occurs. The NTP server sends time, that is, the result of computation that is performed based on standard time and an error range attributable to the stratum while referring to a reference and a stratum that were sent by the client when the request was made, to the client. Accordingly, the NTP server can synchronize computers on a network within an error range of 200 ms.

The schedule synchronizer 43 is provided to synchronize the schedule stored in the schedule database 30 with a schedule stored in the corresponding agent. There may be further included a schedule updater (not shown) that synchronizes an updated schedule through the schedule synchronizer 43 without the intervention of the schedule event queue 21 when the schedule stored in the schedule database 30 is updated.

The communication unit 50 is provided to communicate with the citizen over the Internet or through a mobile terminal and to communicate with each agent. The communication unit 50 may include at least one of a WEB, a WAS, and a SOAP. The WAS is a web application server, and is middleware (a software engine) that executes an application for a user computer or a device over the Internet through HTTP. The SOAP is a communication protocol between entities that enables a web service to be actually used. SOAP is a technology that enables a web service to communicate over the Internet, and may include the SOAP header, the SOAP body, the SOAP Encoding Rules, and the SOAP RPC Representation.

The communication unit 50 transfers event information received from each citizen to the control unit 60. Scripts that the control unit 60 transfers to the individual agents are transferred to the agents through the communication unit 50. The communication between the agents and the city facility managing server 1 may be connected using the SOAP.

The control unit 60 is provided to control each element, to act as a channel for the commands and input and output of each element, to perform control so that each command can be transferred to a corresponding entity, and to command each element to perform a corresponding function. The control unit 60 may perform the function of the scheduled distribution of content used in the field and software run in the control PC. Since a facility is not always operated, but instead operated on a specific date, on a specific day of the week and in a specific time span, the control unit 60 registers the operating schedule of each facility and its component equipment, and transfers commands to control the facility and the component equipment to a corresponding agent in accordance with the schedule.

The agent 2 includes a scheduler 200, a schedule database 300, a synchronization unit 400, a communication unit 500, and a control unit 600.

The scheduler 200 includes a schedule event queue 210. The schedule event queue 210 is a spot at which the scheduler 200 registers each schedule and event read from the schedule database 300, is one basic data structure, and may store data in a FIFO structure.

The scheduler 200 is responsible for the control of devices that manage connected facilities, and power control based on a predetermined operating schedule. When an approved citizen's schedule is sent from the city facility managing server 1 to the communication unit 50, the scheduler 200 stores the above schedule in the schedule database 300. When the time synchronizer 410 and schedule synchronizer 430 of the synchronization unit 400 synchronize the schedule of the schedule database 300 using the synchronization of the time synchronizer 41 and schedule synchronizer 43 of the synchronization unit 40, the event desired by the citizen can be realized using the facility at the accurate time.

When the scheduler 200 generates events at predetermined intervals, preferably at intervals ranging from 1 ms to 20 ms, and more preferably at intervals of 10 ms, and compares the times of the events registered in the schedule event queue 210 with the current time, and generates the events, the schedule database 300 may store the approved schedule and event stored in the schedule database 300 by the citizen, for example, with “in the electronic signboard of Seoul Railroad Station at 8 P.M.” being associated with the schedule and “JYJ music video” being associated with the event, in the form of a data structure, such as that shown in the following Equation 3:

In the electronic signboard of Seoul Railroad Station at 8 P.M.-JYJ music video (3)

The synchronization unit 400 includes a time synchronizer 410 and a schedule synchronizer 430. The time synchronizer 410 is configured to manage the current time and to perform synchronization with the city facility managing server. This synchronization may be performed through an NTP server.

Since the above synchronization and the scheduler 200 are provided, events received from the city facility managing server 1 have been stored in the schedule database 300 and the scheduler 200 itself and self operation can be performed using the stored events, even when control cannot be performed because of the breakdown of the city facility managing server 1 or a power failure, so that independent operation can be performed regardless of the breakdown of the city facility managing server 1.

The NTP server manages the NTP, and functions to send time to a client who requests the time according to the NTP. In the case of a system to which components are connected in steps, when notification of time is provided to computers constituting the agents 2 and the server 1, a stratum occurs. The NTP server sends time, that is, the result of computation that is performed based on standard time and an error range attributable to the stratum while referring to a reference and a stratum that were sent by the client when the request was made, to the client. Accordingly, the NTP server can synchronize computers on a network within an error range of 200 ms.

The schedule synchronizer 430 is provided to synchronize the schedule stored in the schedule database 300 with a schedule stored in the corresponding agent. There may be further included a schedule updater (not shown) that synchronizes an updated schedule through the schedule synchronizer 430 without the intervention of the schedule event queue 210 when the schedule stored in the schedule database 300 is updated.

The communication unit 500 is provided to communicate with the citizen over the Internet or through a mobile terminal and to communicate with each agent 2. The communication unit 500 may include at least one of a WEB, a WAS, and a SOAP. Preferably, a connection to the city facility managing server 1 is established through the SOAP RPC, and, thereafter, information about the operating schedule of the facility devices and information about the organizing schedule of content can be managed, and content files and a variety of types of software can be managed and distributed.

The control unit 600 is provided to control each element, to act as a channel for the commands and input and output of each element, to perform control so that each command can be transferred to a corresponding entity, and to command each element to perform a corresponding function. The control unit 600 may perform the function of the scheduled distribution of content used in the field and software run in the control PC. Since a facility is not always operated but operated on a specific date, on a specific day of the week and in a specific time span, the control unit 600 registers the operating schedule of each facility and its component equipment, and transfers commands to control the facility and the component equipment to a corresponding agent in accordance with the schedule.

Furthermore, the control unit 600 manages physical connections to a variety of types of devices, manages information about the connections of the individual devices, executes commands related to the individual devices, sends the results of the execution of the commands, and generates individual device control blocks by parsing scripts received from the city facility managing server 1 using a script parser.

An output unit 700 is formed of a content player, and is responsible for the playing of content that should be presented by each of the facilities. When a content playing program is generated in the control unit 600 by the scheduler 200, the output unit 700 functions to cause content to be generated and presented at the predetermined time.

Furthermore, a user interface (not shown) may be provided such that an administrator directly performs management. Information about the physical connection of the devices managed by the agent 2, that is, COM ports, speeds, IP addresses, port numbers, and channel information, may be independently stored using the user interface. Control blocks are completed using the connection information when the control blocks are generated by parsing scripts received from the city facility managing server 1, and power control information is also stored and managed for a case having its own power control function and a case having no power control function through the user interface.

That is, in order to control the power of a variety of facilities and the component equipment thereof, the control unit 600 classifies all pieces of equipment. That is, the control unit 600 classifies all pieces of equipment into equipment having its own power control function and equipment having no power control function and requiring power control. Power control is also performed using scripts.

The equipment having its own power control function directly performs power control. In contrast, power is applied to the equipment having no power control function through power control equipment, and the power of the corresponding equipment is controlled through the power control channel of the power control equipment connected to the corresponding equipment.

The ID of control target equipment, and each control command and the value thereof are extracted from scripts received from the city facility managing server 1 through the communication unit 500, and basic information that is used by the control unit 600 to generate control blocks is prepared and returned.

The agent 2 according to this embodiment of the present invention may include a data tier, a business tier, and a presentation tier. The data tier includes an XML file that stores information about facilities, data about facility component equipment, information about content, and information about the operating schedule of content-related component equipment that are received from the city facility managing server 1. This file stores basic information that enables the management and operation of a facility to be independently maintained and performed even when a server trouble or a network trouble occurs. A component module that is directly responsible for this is the control unit 600.

The business tier has the function of controlling the overall component equipment of the control unit 600 and controlling content execution control, and causes a SOAP module to process commands and data received from the city facility managing server 1. A command to control equipment is transferred to the control unit 600, and content is played through the output unit 700.

Here, if a command received from the city facility managing server 1 through the communication unit 500 including the SOAP module is an equipment control command, the control unit 600 receives the command, and performs the functions of equipment operating time change, equipment control, equipment pattern designation and equipment power control. If a command received through the communication unit 500 including the SOAP module corresponds to content, the functions of content registration, content playing time change, play list change, and the control of the content player are performed.

If a command that the SOAP module receives from the server is a command to distribute software, the corresponding software is downloaded by running a downloader, and all executable files of the agent 2 are updated by checking the integrity of files and executing patches in order to apply the new software. If a command that the SOAP module receives is a command to distribute content, a corresponding content file is downloaded by running a downloader and is then stored, and information about the corresponding content (a file name and a link) is also stored.

The presentation tier is divided into a user interface and a content player. The user interface performs functions chiefly required by a field administrator and a field installer, which are GUI functions including the functions of equipment registration, equipment connection information settings, and troubleshooting registration.

The content player directly controls component equipment capable of performing actual visual and auditory presentation. The content player is an element that runs and controls sub-players based on a content file by directly controlling sub-players suitable for the characteristics of the content. Examples of the content play are listed in the following Table 3:

TABLE 3

| | | | | |
|---|---|---|---|---|
| | | | | binary |
| Presentation | media player | flash player | text emitter | player |

| | |
|---|---|
| Control | content player |
| Schedule | scheduler |

The media player is a player that plays files such as a moving image or music, the flash player is a player that plays flash media such as a moving photo, the text emitter is a player that displays text, such as letters, on an electronic signboard, and the binary player is a player that plays a moving image and a music file.

Furthermore, most facilities and their component equipment have the function of presenting patterns or content, and have a control interface based on remote control or its own program. In the case in which such an interface is provided, control is performed using scripts. In contrast, in the case in which no such interface is provided, an Object Linking and Embedding (OLE) Control eXtension (OCX) provided by the system disclosed in this application is provided, and therefore an interface capable of controlling a corresponding facility and corresponding equipment is provided, thereby operating in conjunction with the system of the present invention.

Accordingly, control functions are defined using scripts as common media managing a variety of facilities and their component equipment, the definitions of the functions are transferred to the agent through the scripts, and the agent determines the details of the control functions and performs the control functions according to different standards for different types of target equipment.

Furthermore, a communication protocol that is used between the agent 2 and the server 1 is configured to efficiently manage facilities and equipment installed throughout an urban area. In light of the fact that the facilities are not installed in limited spaces and according to limited rules, a server-client relationship is provided to prevent the installation of a firewall and a router from being limited.

Furthermore, in the case of a remote facility, communication with the facility may be locally interrupted by an unexpected event, the agent 2 is equipped with the scheduler 200 in order to independently manage the control target facility and component equipment and performs such control independently. The operating schedule is configured to always be synchronized with the schedule of the management server 1 by frequent communication with the server 1.

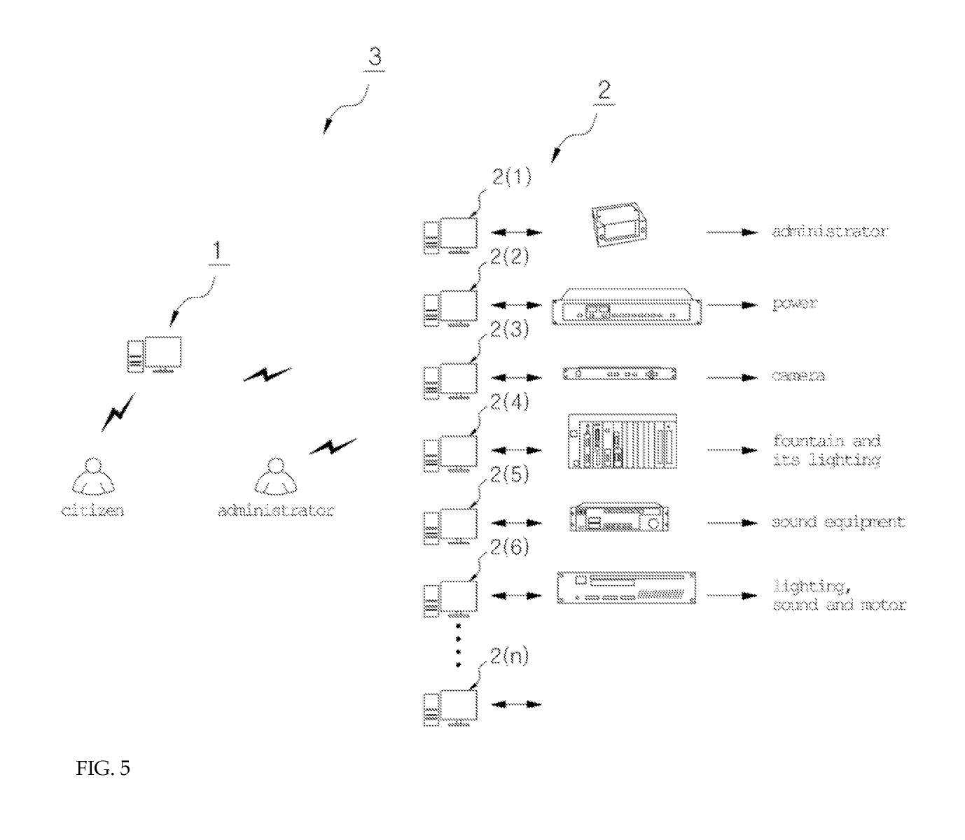

FIG. 5 is a diagram showing an embodiment in which the city facility managing system, which is shown in FIG. 4, has been embodied. As shown in FIG. 5, a server 1 is installed to manage a plurality of agents 2, and the agents 2 control lighting equipment, power, a camera, a fountain and its lighting, sound equipment, lighting, sound and a motor, etc., respectively. The server 1 is not limited to the illustrated one, but may be used as an integrated server that can cover the entire country.

For example, the lighting equipment may be controlled by a DMX controller, the power may be controlled by a power distributer, the camera may be controlled by a camera control unit, the fountain and its lighting may be controlled by a water show controller, the sound equipment may be controlled by a mixer, and the lighting, sound and motor may be controlled by a show controller. These agents 2 can operate independently, and can be managed by the city facility managing server 1 in an integrated manner.

Here, it will be apparent that any type of facility, including a fountain, an electronic signboard, lighting, a moving image, a beam projector, and a laser, can be operated.

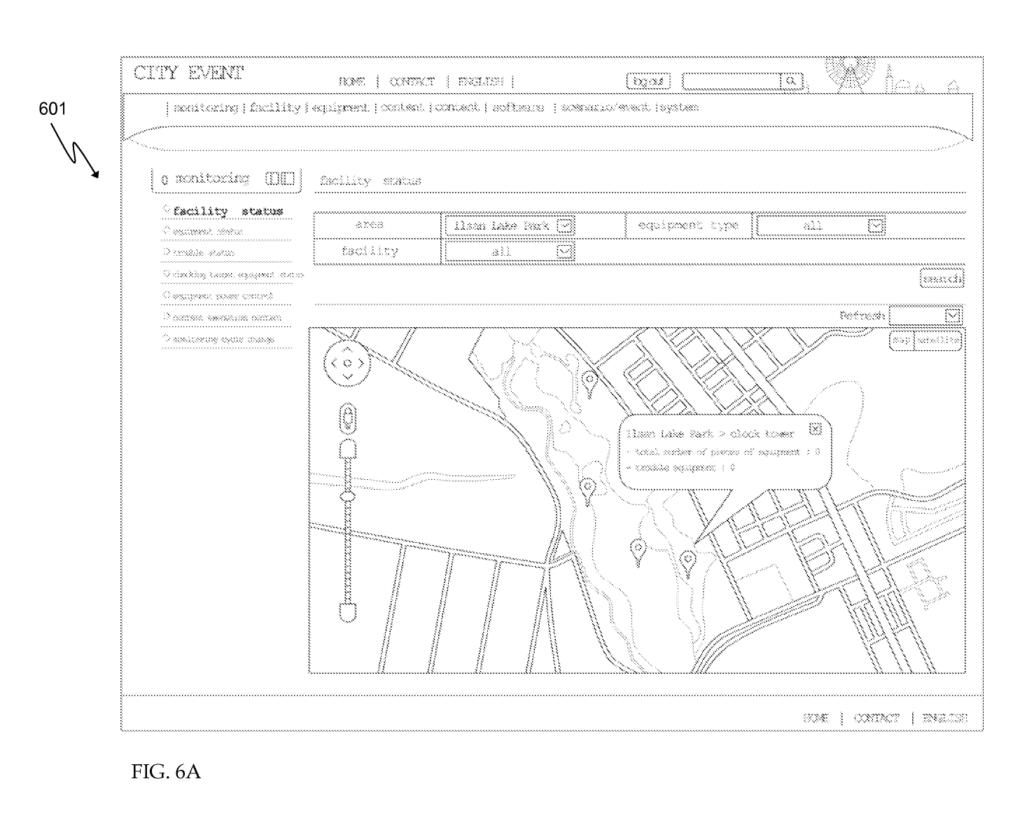

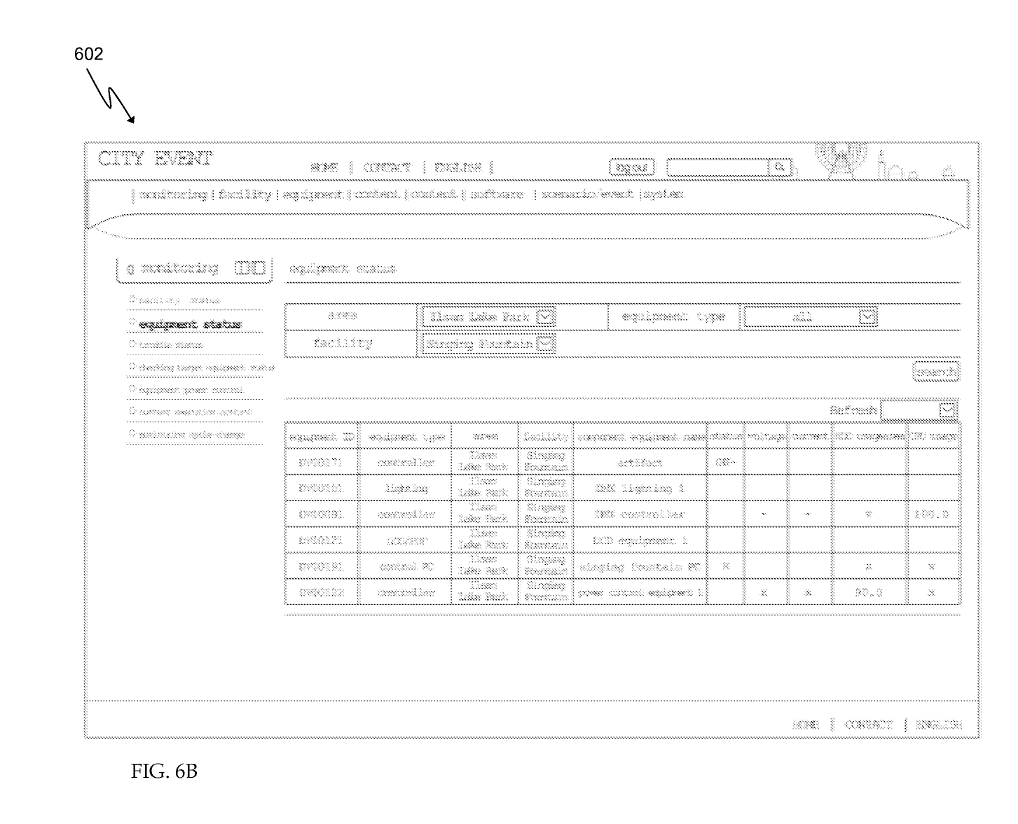

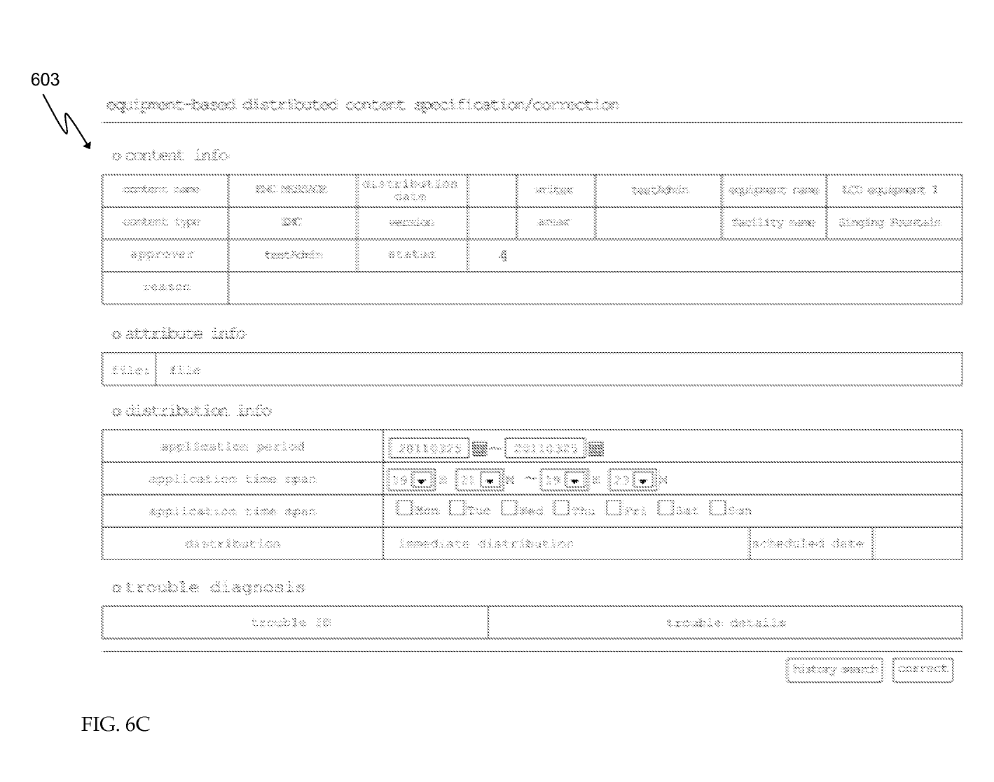

FIGS. 6A, 6B and 6C are screenshots of administrator screens of a program server that has been implemented in the server of the city facility managing system, which is shown in FIG. 4. As shown in FIG. 6A, the administrator may manage the current status of facilities over the Internet, and may receive information about the status of the facilities and their equipment in an area subject to management. This administrator screen 601 is provided to indicate the current status in which a total of four pieces of equipment are present in the clock tower of Ilsan Lake Park and there is no equipment having trouble.

Here, as shown in FIG. 6B, the current status of the pieces of equipment is viewed on administrator screen 602 to check each piece of equipment. The current status of the pieces of equipment indicates that the singing fountain of Ilsan Lake Park is turned on, a DMX controller that operates the fountain is using the entire CPU, and the free space of the hard disk of the control PC of power control equipment is 90 GB. The status of the pieces of equipment can be viewed at a single glance.

The file and application schedule of content distributed for each piece of equipment may be modified. As shown in the administrator screen 603 of FIG. 6c, with regard to distribution information, an application period, an application time span, and one or more days of the week may be set. Whether these settings will be immediately applied may be selected.

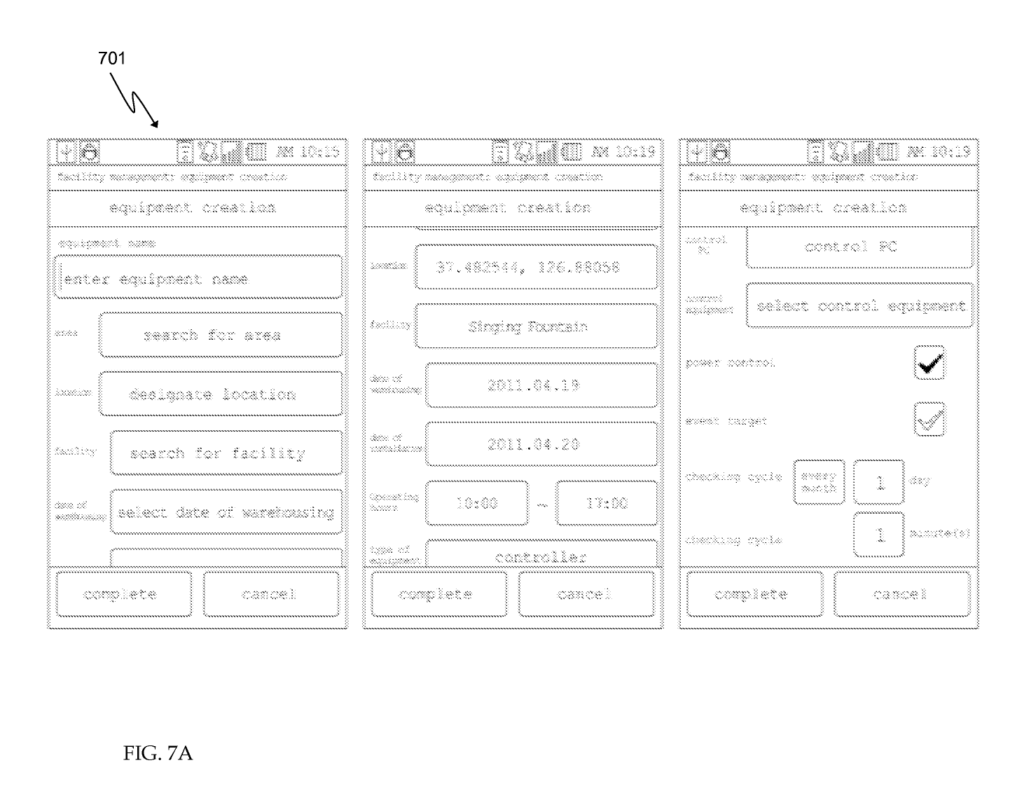

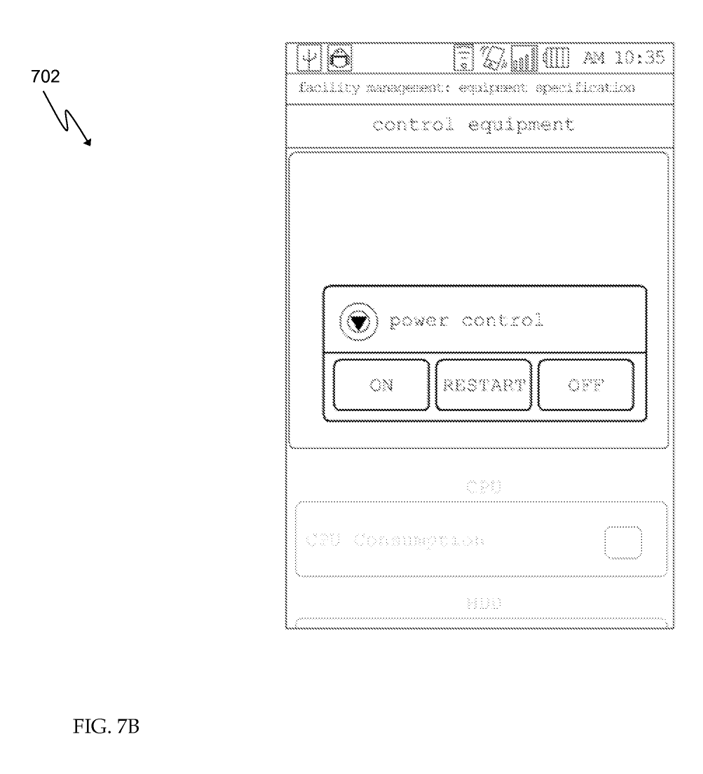

FIGS. 7A and 7B are screenshots 701 and 702, respectively, of administrator screens of a mobile app that operates the agent of the city facility managing system, which is shown in FIG. 4. As shown in FIG. 7A, the app may be used over the web, and may be downloaded to a mobile terminal. Accordingly, when equipment is registered in the field, a field management app may be downloaded without requiring a netbook computer or a notebook computer and then information may be input. In order to enable power control to be performed in the field, the power control may be set, as shown in FIG. 7B. That is, the power control may be set to “Restart,” “On,” or “Off.”

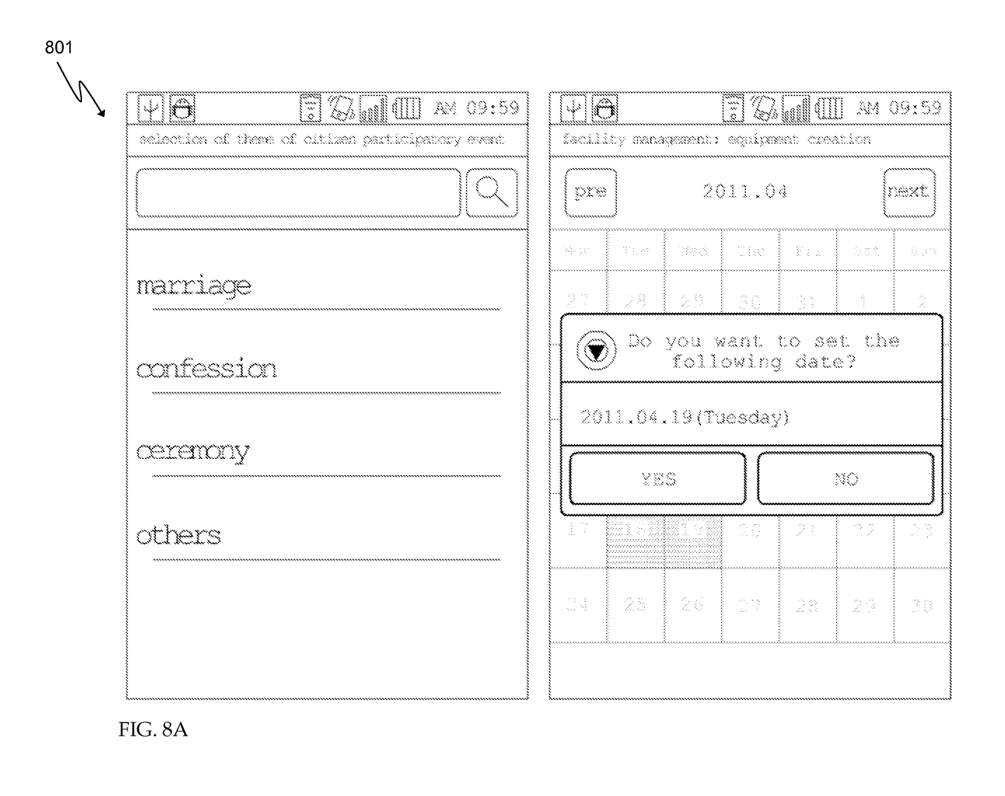

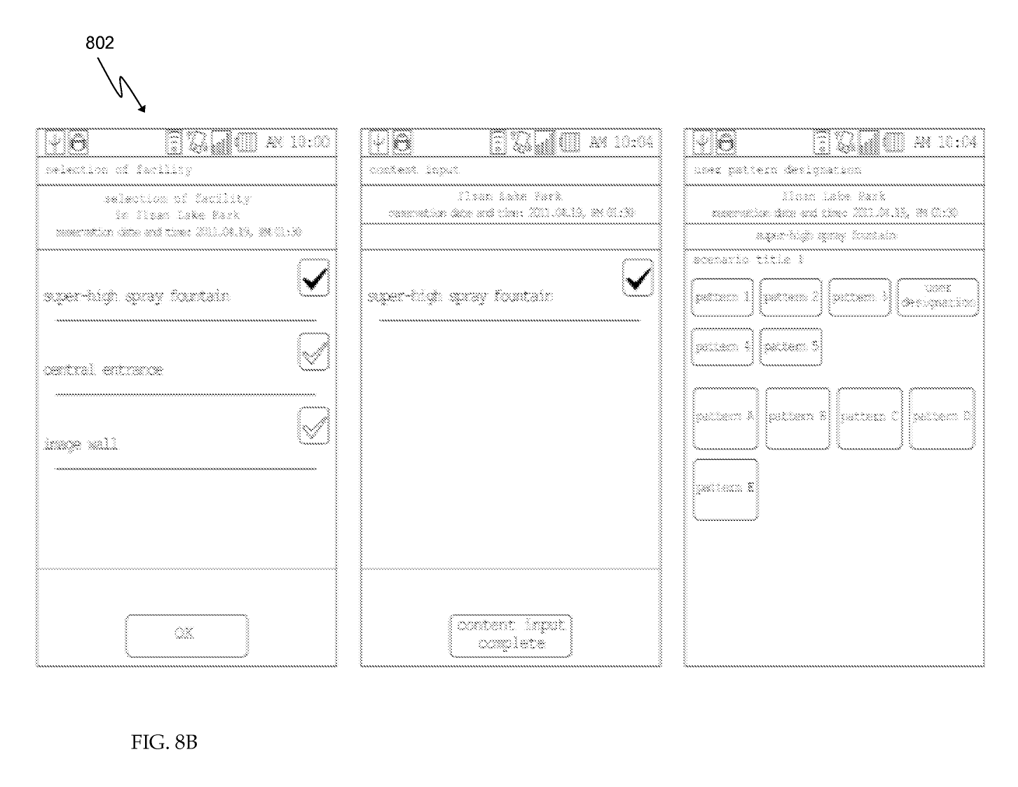

FIGS. 8A and 8B are screenshots 801 and 802, respectively, of user screens of a program that registers events in the server of the city facility managing system, which is shown in FIG. 4.

As shown in FIG. 8A, events in which citizens can participate include a variety of events such as a proposal of marriage, a confession, a ceremony, and others. This screen is merely an embodiment of the present invention. It will be apparent that the present invention is not limited to the screen or user interface.

Here, using a show event request app, the type of event and a scheduled date, that is, a schedule, may be set. As shown in FIG. 8B, a target facility may be selected, and a pattern to be applied to the selected facility may be selected. It is preferable to show a schedule list to a user in order to prevent the user from selecting a time span if a reservation has been made for the same facility for the time span.

The present invention can manage the trouble of devices in an integrated manner, can control the management and power of all facilities in designated time spans, can direct shows based on scenarios, set sequences and/or event participants, can control a new type of equipment using management data other than a change of agent software based on a method using a standardized equipment device control module, rather than a low equipment-based device control method, even when a new type of equipment is added, and can manage facilities, component equipment, and content using the agents' own scheduling functions even in the case of loss of control attributable to trouble with the management server or network.

While a conventional technology can manage only facilities, component equipment and content that have been defined in advance because of the presence of a variety of types of facilities and a variety of types of component equipment thereof, the present invention provides an integrated and independent management and operation solution that can operate a variety of types of facilities and a variety of types of component equipment thereof independently while managing them in an integrated manner.

As described above, the present invention has the advantage of implementing both integrated and independent control of facilities because the present invention can manage and operate the facilities in an integrated manner and also can independently manage and operate the facilities when the control of the management server breaks down, the advantage of significantly reducing the facility management cost because the present invention can manage the trouble of individual pieces of equipment in an integrated manner, the advantage of directing a show based on a scenario, a designated sequence and the content of a show event participant, so that the participant can be an active agent who controls a corresponding facility and the facilities under the control of the city facility managing server may be provided in the form of interactive facilities, and the advantage of being able to control new equipment by using management data, rather than by changing an agent to fit the equipment, when the new equipment is added, so that the cost of changing and adding software can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A city facility managing server being connected to a plurality of agents, each of which manages at least one city facility according to event processing scripts, the city facility managing server comprising:
a schedule database configured to store schedules, each including a specific event processing script controlling at least one specific city facility;
a schedule register configured to register the schedules in the schedule database; and
a scheduler configured to continuously read the stored schedules, register the schedules in an event queue, read a schedule corresponding to a current time from the schedule event queue, and send the read schedule to at least one corresponding agent, thereby allowing the at least one corresponding agent to control a corresponding city facility according to a corresponding event processing script.

2. The city facility managing server of claim 1, further comprising a time synchronizer configured to manage the current time and perform synchronization with the plurality of agents.

3. The city facility managing server of claim 2, wherein the synchronization is performed through a Network Time Protocol (NTP) server.

4. The city facility managing server of claim 1, wherein the scheduler causes the corresponding agent to store the sent schedule prior to processing the corresponding event processing script so that the corresponding event processing script can be executed even when a disruption occurs in the city facility managing server.

5. The city facility managing server of claim 4, further comprising a schedule synchronizer configured to synchronize the schedule stored in the schedule database with a schedule stored in the corresponding agent.

6. The city facility managing server of claim 5, further comprising a schedule updater configured to, when the schedule stored in the schedule database has been updated, synchronize the updated schedule through the schedule synchronizer without intervention of the schedule event queue.

7. The city facility managing server of claim 1, wherein the schedule register, when a participatory show event has been received in a form of the schedule including the specific event processing script through a mobile terminal or an Internet, checks the schedule stored in the schedule database prior to the registration.

8. The city facility managing server of claim 7, wherein the participatory show event includes a scenario, including functional and temporal control of the at least one specific city facility, as the specific event processing script.

9. The city facility managing server of claim 1, further comprising a pre-scheduler configured to, prior to fetching the schedule corresponding to the current time, check the at least one specific city facility for erroneous operation through the at least one corresponding agent.

10. The city facility managing server of claim 9, wherein the pre-scheduler performs the above checking on at least one schedule at a front of the schedule event queue, and, if the erroneous operation is not predicted to occur, deletes the corresponding schedule from the schedule event queue.

11. A city facility managing system including a city facility managing server, the city facility managing server being connected to a plurality of agents each of which manages at least one city facility according to event processing scripts, the city facility managing system comprising:
a schedule database configured to store schedules, each including a specific event processing script controlling at least one specific city facility;
a schedule register configured to register the schedules in the schedule database;
a scheduler configured to continuously read the stored schedules, register the schedules in an event queue, read a schedule corresponding to a current time from the schedule event queue, and send the read schedule to at least one corresponding agent, thereby allowing the at least one corresponding agent to control a corresponding city facility according to a corresponding event processing script; and
the plurality of agents configured to synchronize time and schedules with those of the city facility managing server, and store event processing scripts, thereby independently operating the facilities even when disconnection occurs.

12. The city facility managing system of claim 11, wherein each of the city facility managing server and the agents further comprises a time synchronizer configured to manage the current time and perform synchronization with the plurality of agents.

13. The city facility managing system of claim 12, wherein the synchronization is performed through an NTP server.

14. The city facility managing system of claim 12, wherein each of the agents further comprises a scheduler, and the scheduler of the city facility managing server causes the corresponding agent to store the sent schedule prior to processing the corresponding event processing script so that the corresponding event processing script can be executed even when trouble occurs in the city facility managing server.

15. The city facility managing system of claim 14, wherein each of the city facility managing server and the agents further comprises a schedule synchronizer configured to synchronize the schedule stored in the schedule database with a schedule stored in the corresponding agent.

16. The s city facility managing ystem of claim 15, wherein each of the city facility managing server and the agents further comprises a schedule updater configured to, when the schedule stored in the schedule database has been updated, synchronize the updated schedule through the schedule synchronizer without intervention of the schedule event queue.

17. The city facility managing system of claim 11, wherein the schedule register, when a participatory show event has been received in a form of the schedule including the specific event processing script through a mobile terminal or an Internet, checks the schedule stored in the schedule database prior to the registration.

18. The city facility managing system of claim 17, wherein the participatory show event includes a scenario, including functional and temporal control of the at least one specific city facility, as the specific event processing script.

19. The city facility managing system of claim 11, wherein the city facility managing server further comprises a pre-scheduler configured to, prior to fetching the schedule corresponding to the current time, check the at least one specific city facility for erroneous operation through the at least one corresponding agent.

20. The city facility managing system of claim 19, wherein the pre-scheduler performs the above checking on at least one schedule at a front of the schedule event queue, and, if the erroneous operation is not predicted to occur, deletes the corresponding schedule from the schedule event queue.
